(19) United States
(12) Patent Application Publication
(10) Pub. No.: US 2003/0179073 A1
(43) Pub. Date: Sep. 25, 2003

(54) Electronic secure locking system

(76) Inventor: Ohanes Ghazarian, Henderson, NV (US)

Correspondence Address: OHANES GHAZARIAN, 308 GONDOLA WAY, HENDERSON, NV, 89074, US

(21) Appl. No.: 10/392,663

(22) Filed: Mar. 19, 2003

Related U.S. Application Data
(60) Provisional application No. 60/366,310, filed on Mar. 20, 2002.

(51) Int. Cl. H04Q 1/00; G05B 19/00

(52) U.S. Cl. 340/5.6; 340/5.61

(57) ABSTRACT

An object of the present invention is to provide a method and apparatus for inhibiting unauthorized utilization of a protected devise, such as a container with electronic locking mechanism installed in the inner side of a container door(s), it is provided for permitting access through the container door. Such mechanism includes electronic lock(s) containing a processor CPU to store container unique ID information. And for controlling the container door lock mechanism, with a means for releasing lock mechanism, includes a portable self-powered electronic reader/controller apparatus. The reader/controller is equipped with a receptacle, which provides power and communicates with container electronic locking processor, through the container mount receptacle terminals or wireless signal(s). For portable/controller user access and for user Identification, the portable reader/controller contains a, magnetic card, RFID card, and smart card, or biometric reader.

In a preferred embodiment of the invention, the portable reader/controller comprises of a PDA equipped with a GPS antenna and a GPS map in its database. At port of origin the container given destination GPS address is downloaded into said container lock processor. When container is at given destination location address, the container lock processor upon receipt of PDA location GPS signal, compares in it's database received PDA actual location GPS address along with given container ID code, with previously stored at port of origin given destination GPS address. If the actual received GPS location address and previously given port of origin destination address is a match, the processor signals to the locking mechanism to unlock containers door.

### BACKGROUND OF INVENTION

The present invention relates to a method and apparatus for inhibiting unauthorized utilization of a protected devise, such as a container with electronic locking mechanism installed in the inner side of a container door(s), it is provided for permitting access through the container door. Such mechanism includes electronic lock(s) with a built-in processor, and a portable reader/controller designed to provide power and communicate with the door lock processor to securely open the doors of a container located at a location.

In the passed various attempts have been made to develop devises to prevent unauthorized utilization of protective devises, such as a container. One such system is illustrated in U.S. Pat. No. 5,196,841 to Harder et al. where a locking system for a security door comprises a lock mounted on the inner surface of the door and an operating system located outside of the door. an inputting keyboard has been used for numeric combination on the outside of the door to open the security door.

U.S. Pat. No. 5,225,825 to Warren; Which illustrates an electronic interlock for locking a cabinet, and for limiting the numbers of drawers to be accessed at any given time. An input keyboard receives an input code to be compared with a pre-stored access code. If the input code matches the access code, a processor renders the storage assemble accessible.

U.S. Pat. No. 5,774,059 to Henry et al which teaches a microprocessor based programmable electronic lock which provides level of security by use of a time clock early feature for securing the lock with prior programmable locking time, using a keyboard for pin code entry for security. The electronic lock is not responsive to said key when said key is idle for programmable period of time.

U.S. Pat. No. 5,774,066 to Pellaton et al. teaches a programmable activation system of the timed locking/unlocking of a security installation includes at least one activation module, and an apparatus for controlling the module to program a time value corresponding to the precise moment where the activation module will cause the unlocking of the element.

U.S. Pat. No. 5,905,446 to Benore et al. teaches an electronic security system for controlling access to a plurality of storage locations. The system includes an electronic lock associated with each storage location, a central control terminal for controlling operation of the security system, a programmer programming terminals plurality of keys, and an identification terminal for identifying the user.

U.S. Pat. No. 6,049,448 to Lanigan et al. discloses a security system with a driver circuit for energizing a solenoid actuated locking device. The circuit includes a microprocessor, a battery power supply, a boosting circuit and energy storage circuit. It utilized a boosting circuit to actuate the solenoids locking devises. The security system particularly adapted for roll down doors and enclosures.

U.S. Pat. No. 6,130,621 to Wiess which discloses a method and apparatus for inhibiting unauthorized access to or utilization of a container or other protective device wherein a free standing lock or other control is provided, which may switch to an unlock state in response to verification that an authorized non-predictable code has been received from a token before a time out.

And finally U.S. Pat. No. 6,356,193 B1 to Liou describes a self safety-protection burglarproof device comprising of un-interruptible power, an image- capturing unit, an access unit, a lock head, a receiver, a server, a lock mechanism, a control unit, a sensing unit, and a case-reporting unit. The lock head is at an on state so that input power can be provided to the receiver when the keyhole of the lock head is inserted by a key. When the receiver receives a remote-control signal, the server will activate the control unit to stay at a state of alert, and the lock mechanism will be driven to unlock.

The Harder et al., Warren, Henry et al., Pellaton et al., Benore et al., Lanigan et al., Weiss, and Liou teaching as briefly illustrated both benefits and the security limitation of such systems as they are currently know. As illustrated none of the prior art founding utilizes a portable hand held reader/controller, that requires user identification to operate the reader/controller by means of, user magnetic card, a smart card, RFID card and in particularly user biometric reading to identify the user, and accordingly allows the user to operate the hand held reader/controller to open a particular container door lock mechanism.

Further more none of the prior art founding teaches the use of a container door having electronic lock incorporated with a processor, which stores in processors memory a given destination GPS address. And non of prior art teaching utilizes a hand held PDA equipped with a built-in GPS receiver and a map, used for opening a container electronic door lock mechanism, based on container door lock processor stored given destination GPS address, and actual container location and hand held PDA location received GPS signal address. And none of prior art utilizes a GPS based hand held PDA which contains a wireless modem to communicates with a base station computer with information relating to plurality of containers location, container content, container port of origin, Loader ID information, vessel name, and reader/controller or PDA user (inspecting officer) ID information.

It is accordingly the primary objective of the present invention that provide an electronic secure locking system, for inhibiting unauthorized utilization of a protected devise, such as a container with electronic locking mechanism installed in the inner side of a container door(s). And for controlling the container door lock mechanism, with means for releasing container door lock mechanism, includes a portable self-powered electronic reader/controller, which utilizes an improved user Identification method for permitting access for the operation of the portable reader/controller unit, by means of a magnetic card, RFID card, smart card, and in particularly using a biometric reader to ascertain identity of the user.

It is further objective of the present invention that utilizes an electronic container door lock mechanism containing a processor, which stores in its memory a particular container given destination address by means of GPS longitude/latitude address, and provides authorized personnel a portable PDA equipped with a GPS antenna and a GPS map to ascertain the container be open only by authorized personnel at given destination GPS address by use of Hand held GPS based PDA unit.

### SUMMERY OF THE INVENTION

An object of the present invention is to provide a method and apparatus for inhibiting unauthorized utilization of a protected devise, such as a container with electronic locking mechanism installed inside the container, it is provided for permitting access through the container door. Such mechanism includes electronic lock(s) containing a processor to store container unique ID code, port of origin, container content manifest, destination(s) address, and for controlling the container door lock mechanism, with a means for releasing the lock(s) to permit access. Said door lock processor is connected to a receptacle, mounted on the outer side of a container to receive power and to communication with data through said container receptacle, by means of contact terminals or wireless signal(s). The means for releasing includes a portable self-powered electronic reader/controller apparatus. The reader/controller is equipped with a receptacle, which provides power and communicates with container electronic locking processor, through the container mount receptacle terminals or wireless signal(s). For portable/controller user access and for user Identification, the portable reader/controller unit contains a, magnetic card, RFID card, smart card, or biometric reader.

When a particular container need to be opened for inspection or delivery of goods, the user enters user magnetic card, or presents user RFID tag (Card) or puts user finger on reader/controller apparatus biometric reader, for user identification and for user access to operate the reader/controller apparatus. Then the user connects the hand held reader/controllers receptacle in contact with the container mount receptacle, the reader/controller unit power-up the container door lock processor, and locking processor upon power up, transmits a unique coded signal containing information to container ID code. The reader/controller unit upon receipt of the container door lock processor code, displays on the reader controller LCD/TFT screen, the read container ID code and transmits a unique coded signal to the electronic lock processor, containing information to matching container ID code, and user code. The processor, upon receipt of the signal energies the electromechanical lock to unlock the container locking mechanism, and logs in to the processor data base last user code and date. When the portable reader/controller is disconnected, the processor powers down.

In a preferred embodiment of the invention each one of plurality of containers electronic door lock mechanism is equipped with a processor having a unique code, and its powered by a portable reader/controller having a receptacle. And each one of the plurality of container relating information, such as container ID number, Vessel name, port of origin, loader ID, container content information is stored in an intranet or Internet database. The portable hand controller unit has download and upload ability. When an operator desires to open a particular container(s) for inspection, the operator downloads from the intemet/intranet the necessary information (Container ID, vessel name, port of origin, container content, and loader ID) into the hand held reader/controller, which provides into the hand held controller unit information relating to plurality of containers located at a location. To open a particular container door, the operator connects the hand held controller into a particular container receptacle and for operating the portable reader/controller user presents a user tag or user finger into portable/reader controller, and selects a particular container ID code, the hand controller sends the particular container unique ID code to container Lock processor, and the processor upon receipt of a matching code will initiate a signal to release container door lock mechanism.

In a further embodiment of present invention, a hand held PDA equipped with a GPS antenna is used to download into containers lock processor, container actual loading address, the container content manifest, and given destination GPS address(s). When the container arrives the given destination address(s), the PDA user (custom officer, Driver or loader) to released the container locking mechanism, connects the hand held PDA equipped with GPS receiver into the container receptacle, the PDA powers up the electronic locking processor, the PDA reads the container lock processor code, and the user enters or presents readable access code (RFID, Biometric ID) into the PDA unit. The PDA unit transmits user access code and container ID code, along with PDA actual location received GPS satellite (longitude/latitude) signal information into electronic locking mechanism processor, the lock processor upon receipt of signal compares in it's database received PDA actual location GPS address with previously stored GPS destination location address in processors memory, if the actual location GPS address and previously stored port of origin given destination address is a match, the processor signals to the locking mechanism to unlock containers door.

In a preferred embodiment of the present invention, the reader/controller or the PDA used in the present invention additionally be incorporated with a built-in RF transceiver, wireless cellular, or satellite modem, which wirelessly communicates with a base station computer interface unit for wirelessly downloading/uploading all communication information relating to plurality of containers, with a base station computer or with a web server.

### DESCRIPTION OF THE DRAWINGS

This are advantages of the present invention are best understood with reference to the drawing, in which:

FIG. 1 Illustrates a container with 2 doors, one of the doors is equipped with a receptacle which is connected to a processor, and the processor is connected to electronic solenoid locks installed on inner side of container door.

FIG. 2 Illustrates a battery operated portable reader/controller unit with receptacle, built-in RFID reader, Biometric reader, GPS antenna receiver, wireless modem, and serial port communicator.

FIG. 2 Illustrates topside view of receptacle communication terminals.

FIG. 3 Is the Block diagram.

### DETAILED DESCRIPTION OF THE PREFERRED EMBODIMENT

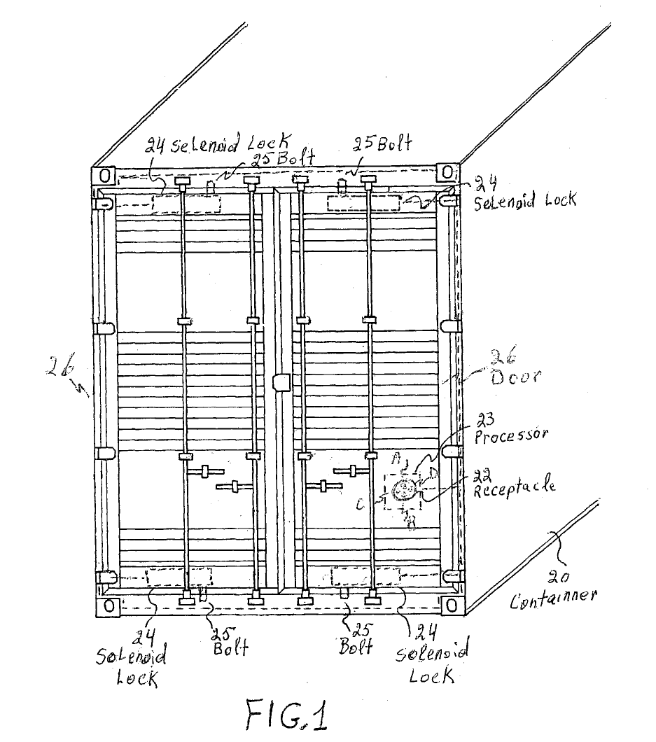

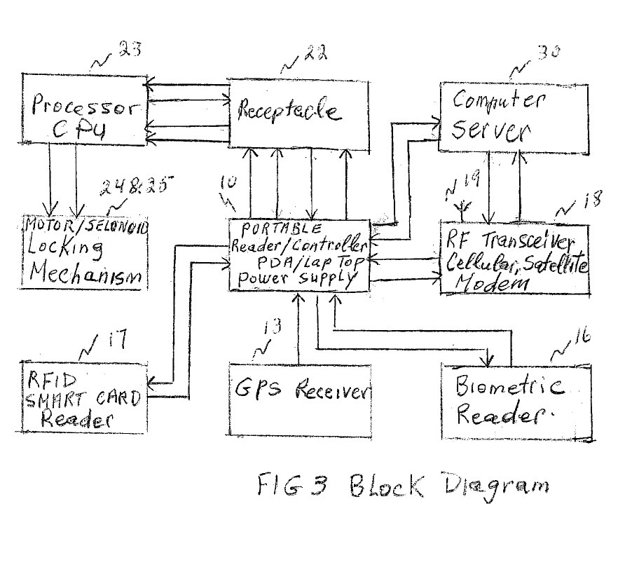

The preferred embodiment of the electronic secure locking system of the present invention is illustrated in block diagram FIG. 3. And as deployed in the exemplary situation in FIG. 1 wherein a container/trailer 20 equipped with a receptacle interface 22 having terminals A, B, C, D used as an interface to pass through power and communication data, to a container processor 23, which is connected to solenoid locks 24 installed on the inner side of the container doors 26, which control the solenoid lock bolt 25 movement to lock and unlock the container doors 26. When the solenoids 24 are energized the bolts 25 are retracted and the container doors 26 could be opened, when energy is removed the solenoid lock 24 releases the bolts 25, then the container doors 26 are locked. Each of the plurality of container processor has a unique identification code stored in container door lock processors 23 memory.

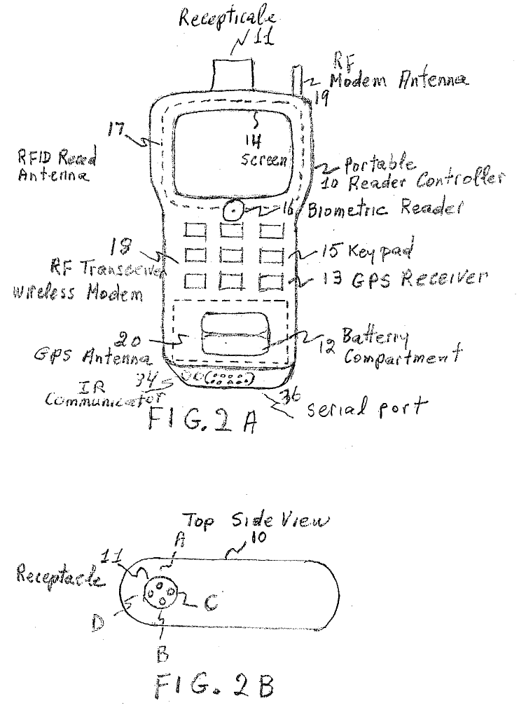

And a hand held portable reader/controller apparatus FIGS. 2A-10 powered by a battery 12 containing a processor, An RFID reader 17, or a biometric reader 16 is used for user identification, and provides user access to operate the portable reader/controller apparatus 10. The reader/controller apparatus utilizes a receptacle 11 having A, B, C, D terminals used to provide power and communicate with a container FIG. 1 door lock processor 23, through said container receptacle interface 22. A keypad 15 and a LCD screen 14 are provided for user to monitor and operate reader/controller 10 operational functions. Additionally a GPS antenna 20 receivers 13 is adapted, for receiving GPS satellite signals and used for programming a container door lock processor 23 with container given destination GPS address through the container receptacle interface 22. An IR 34 or a serial port 36 communicator is provided to upload/download information from a base station computer 30 or internet/intranet server. And an RF transceiver or a wireless modem 18 is additionally incorporated to communicate through reader/controller antenna 19 to download/upload data from a base station computer 30, internet/intranet server.

To operate the portable reader/controller apparatus 10 the authorized user introduces the RFID tag (Card) near the RFID reader antenna 17, for user tag reading. Or user put a finger on the biometric reader 16, or user positions the biometric reader to read user face/eye image. The reader/controller apparatus 10 processor compares in its data base user given ID information, if it is of a match to a previously stored user ID information, then user operates the reader/controller unit 10.

As normal shipping procedure, plurality of shipping containers/trailers manifest is entered in a computer 30, or an intranet/internet database. After a container 20 is loaded and the containers doors 26 are locked, the loader inserts the hand held reader/controller receptacle 11, into the container receptacle 22. the reader/controller apparatus built in power supply (Battery) 12 power up the container door lock processor 23 and user programs container manifest information, which will contain information relating to container port of origin, shipping vessel name, container content information, destination address, loader information, into the container door lock processor by use of reader/controller apparatus key pad 15. into container door lock processor 23, As follows;

A—The hand held reader/controller FIG. 2B. Receptacle 11 terminal A. will provide power to container door lock processor FIGS. 1-23 through container receptacle 22 terminal A.

B—The hand held reader/controller 10 receptacle 11 terminal B. will provide ground signal to container door lock processor FIGS. 1-23 through container receptacle 22 terminal B.

C—The hand held reader/controller 10 receptacle 11 terminal C. will provide communication data out, and D provides communication data in to container door lock processor FIGS. 1-23 through the container receptacle 22 terminal C & D.

Note: The data communication terminals C& D used in the art could be a male female dry contact, or infrared IR communication.

Once the container reader controller processor 23 is programmed, user detaches the portable reader controller apparatus.

At container given destination address (Port of entry) or container on-rout, the inspecting officer or delivery personnel, for inspection or for delivering container content. Connects the hand held reader/controller apparatus 10 to a site computer interface unit, which through use of a serial port 36 or through the use of infrared 34 contact, downloads a single or plurality of containers manifest (Bill of lading) information along with each container door lock processor 23 ID code into the hand held reader/controller apparatus 10.

During container been on rout or when container arrives at given destination address, the inspecting officer or delivery person (Un-loader) after initiating user identification into portable reader/controller apparatus 10, inserts the reader/ controller into container receptacle 22, and the reader/controller apparatus 10 reads container door lock processor 23 ID code along with container manifest, and displays the read information on reader/controller LCD screen 14. If read ID code and read container manifest of a match with the reader/controller processor previously stored container ID code, then the inspector press open command button on the key pad 15, the reader/controller transmits container read ID code into the particular container door lock processor 23, the processor 23 signals to door solenoids 24 to unlock the container door(s) 26.

In a preferred embodiment of the invention for additional security, plurality of container each one of the containers door lock processors 23 are previously programmed with a particular container ID code. The inspecting officer downloads from a base station computer interface a plurality of container ID information along with each one of the plurality container manifests. After given user ID, the inspector inserts the hand held reader/controller 10 in to container receptacle 22 and read container ID code, the reader/controller processor 10 compares the read code with code stored in the reader/controller 10 processors memory, if the reader/controller 10 read code is match, then the reader/controller 10 displays the particular container manifest on reader/controller LCD screen 14, and inspecting officer press command button from the keypad 15, The reader controller then transmits container ID code into container door lock processor 23, and the processor gives signal to door lock solenoid to open the container door(s) 26.

In a further improved embodiment of the present invention, each one of the hands held reader controller apparatus 10 in addition is equipped with a GPS antenna 20 and a receiver 13. The hand held reader controller 10 of present invention, at port of origin the loader or inspector, through the use of GPS reader controller apparatus 10, downloads into container door lock processor 23, a particular container 20 given destination GPS (Longitude/latitude) address(s).

When container 20 arrives the given destination address, the container inspection officer or delivery person, carrying a similar hand held GPS based reader/controller apparatus 10, initiates the user ID procedure, the reader/controller 10 upon receiving authorized user ID, the GPS based hand held reader/controller 10 receives actual reader/controller 10 location GPS satellite signals through built-in GPS antenna 20. For user convenience the reader/controller LCD screen 14 indicates actual reader/controller position on the LCD screen. The inspecting officer press key pad 15 open command button, and the GPS based reader/controller apparatus 10 transmits the received GPS location signals, into the particular container door lock processor 23, through the particular container receptacle 22, which is located at that particular location. The door lock processor 23 receives the Reader/controller 10 transmitted GPS signals, and the processor 23 compares the received signals, with previously stored GPS signal in processors 23 memory. If actual reader/controller 10 given GPS location signal is of a match with door lock processors 23 previously stored given destination GPS address, the door lock processor 23 transmits a signal to containers solenoid lock 24 to unlock the particular container door(s) 26.

Better yet, it is further embodiment of present invention that the hand held reader/controller apparatus 10 used in the present art, has a built in wireless transceiver or a wireless modem 18 using an antenna 19 for wirelessly downloading and uploading all communication and operational functions of reader/controller apparatus 10, with a base station computer 30 interface unit. The base station computer 30 stores all such data relating to the present invention in a secure intranet/intemet database.

What is claimed is:

1- Electronic secure locking system for controlling access to plurality of containers comprising;
a container mount receptacle interface, used for interfacing power and for interfacing data communication.
an electronic door lock mechanism, containing a processor, for storing data and securing said container door(s)
and a microprocessor based reader/controller apparatus having a receptacle, and incorporated with a user access reader, for controlling locking and unlocking of said container door lock mechanism.
And each one of said plurality of container door lock processor has a unique identification code stored in said processor memory.
Said reader/controller, upon electronically reading said apparatus user ID information, said apparatus communicates through said container receptacle, with said particular container door lock processor with a unique coded signal, to unlock said container door.

2- Electronic secure locking system as claimed in claim 1 wherein said reader/controller apparatus electronic user ID reader is a, magnetic card reader, a smart card reader, an RFID reader, an RF key fob reader and or a biometric reader.

3- Electronic secure locking system as claimed in claim 1 wherein said reader controller uploads or downloads data through hardwire or wirelessly into and from a base station computer and or a internet/intranet server, with information relating to plurality of container ID, port of origin, transporting vessel name, container destination address(s), container content, container loader(s) ID, and inspecting officer or delivery personnel ID.

4- Electronic secure locking system as claimed in claim 1 wherein said reader controller uploads or downloads data through said container receptacle hardwired or wirelessly into and from said container electronic door lock processor with information relating to said container ID, port of origin, transporting vessel name, container destination address(s), container content, container loader(s) ID, and inspecting officer or delivery personnel ID.

5- Electronic secure locking system as claimed in claim 1 wherein said Reader/controller apparatus communication with said container door lock processor, contains a unique code signal, for said door lock processor to close said container door.

6- Electronic secure locking as claimed in claim 1 wherein said container door lock mechanism automatically lock said container doors, when set container doors become in close position.

7- Electronic secure locking system as claimed in claim 1 wherein said reader/controller apparatus is powered by a battery, said apparatus provides power into said container door lock processor assembly through said container receptacle interface.

8- Electronic secure locking system as claimed in claim 1 wherein said container door lock processor additionally utilizes a self contain battery as power supply.

9- Electronic secure locking system as claimed in claim 1 wherein said reader/controller apparatus is equipped with a GPS antenna receiver, said GPS apparatus is capable of download a particular container destination GPS address(s) information into said particular container door lock processor database.
And said GPS based apparatus is able to open said container electronic door lock mechanism, when said particular container location, and said GPS based apparatus location is of a match with said container door lock processor given destination GPS location address.

10- Electronic secure locking system as claimed in claim 1 wherein said reader/controller apparatus is portable, a hand held PDA, and or a laptop PC.
